(19) United States
(12) Patent Application Publication
(10) Pub. No.: US 2021/0068930 A1
(43) Pub. Date: Mar. 11, 2021

(54) Impression Post for a Dental Implant

(71) Applicant: EPIPHANOSTICS GMBH, Holzkirchen (DE)

(72) Inventor: Gerhard Neuendorff, Uhingen-Holzhausen (DE)

(73) Assignee: EPIPHANOSTICS GMBH, Holzkirchen (DE)

(21) Appl. No.: 16/813,825

(22) Filed: Mar. 10, 2020

(30) Foreign Application Priority Data
Sep. 11, 2019 (DE) 20 2019 105 013.6

(51) Int. Cl. A61C 8/00

(52) U.S. Cl. CPC A61C 8/0001

(57) ABSTRACT

An impression post for a dental implant includes one pair of sleeves with an inner sleeve, which has a through bore extending longitudinally of the inner sleeve, and an outer sleeve radially surrounding the inner sleeve, which is detachably connected to the inner sleeve, and a fastening element penetrating the through bore of the inner sleeve for fixing the sleeve pair to the dental implant. The outer sleeve has, at the apical end of the outer sleeves facing the dental implant, a preferably annular planar end face which, when the sleeve pair is fixed to the dental implant, rests on a corresponding, preferably planar end face of the dental implant.

### FIELD OF INVENTION

This invention concerns an impression post for a dental implant.

### BACKGROUND AND SUMMARY OF INVENTION

Impression posts are used in dentistry to transfer the position and orientation of a dental implant placed in the jawbone in relation to its surroundings to a so-called master model, which the dental technician uses to fabricate the prosthetic element to be applied to the dental implant.

For this purpose, the impression post usually has an impression cap and a suitable fastening element connected to it for fastening the impression cap to the dental implant. Using an impression tray, the space around the impression post and adjacent tissue structures in the patient's oral region is filled with an initially plastically deformable, curable impression material. The impression material removed from the patient's mouth after curing forms a negative model for fabricating the master model.

Impression posts and corresponding impression methods are known in the state of the art in C. Cacaci et al., “Oral Implantology”, 1st edition, Georg Thieme Verlag Stuttgart, 2006.

For impression taking, a distinction is made between “open tray” and “closed tray” impressions. In the open tray impression, the fastening element, with which the impression cap is attached to the dental implant, is loosened before the impression material is removed from the patient's mouth. Since the fastening element is usually in the form of a screw, the impression tray has a recess in a corresponding area through which the screw can be gripped, for example with a screwdriver. “Open tray” and “Closed tray” impression processes are known to the person skilled in the art and are described—for example—in U.S. Pat. No. 7,066,736.

When the impression tray is removed, the impression cap remains in the impression material for open tray impression taking. Subsequently, an implant analog can be inserted precisely into the impression cap, which in turn is embedded in the hard gypsum when the master cast is constructed. In the master model, the implant analog thus shows exactly the position of the dental implant in the patient's jawbone. Impression posts that can be used for an open tray impression are also described in U.S. Pat. No. 5,213,502 B1 and US-A-2006/0121416.

Usual impression caps often have a polygonal base or a polygonal opening in their apical end area facing the dental implant, which fits exactly to the opening or base in the occlusal end area of the dental implant and should ensure an anti-rotation between the impression cap and the dental implant. This is to ensure that the impression post does not rotate, especially during impression taking, and that the position of the dental implant can be transferred exactly to the implant analog. In addition, since in this case the dental implant has an occlusal opening, the impression material is prevented from penetrating this opening.

However, the static friction between impression cap and dental implant resulting from this anti-rotation lock is relatively high even in axial direction. This is particularly important in the case of simultaneous impression taking of several impression posts standing obliquely to each other. In such cases, the impression material can only be removed by exploiting the elasticity of the impression material, whereby there is a risk that the impression material will be plastically deformed as a result of a greater deflection of the impression post from its position taken during impression taking, which can lead to a change and thus to a falsification of the position transferred to the implant analogue.

The EP-A-1274365 describes an impression post which consists of a lower part which can be fixed in a receiving recess of the implant and an upper part which can be inserted into or placed on the implant, wherein the upper part is linearly removable from the lower part in different directions starting from the connecting position of the impression post.

The disadvantage of the impression post according to EP-A-1274365 is that it is only suitable for highly specific implants. Furthermore, the disadvantage of the impression post is that it has an adhesive ring for fixation to the implant, which can lead to problems with regard to compatibility for the patient.

The WO0143659A1 discloses an impression device for coupling to a bone implant, which comprises a split sleeve with coaxial upper and lower sleeve elements and a fixing screw for clamping the split sleeve to the implant. The fixing screw used penetrates the split sleeve and can be retracted around the assembly after the impression material has cured to allow the upper sleeve element to separate from the lower sleeve element.

Another impression post is described in EP2213259. Accordingly, the impression cap of the impression post comprises an inner sleeve and an outer sleeve radially surrounding the inner sleeve, which is detachably connected to the inner sleeve.

What the state-of-the-art impression systems have in common is that the impression posts used especially for “open tray” impressions cause problems with the simultaneous impression of several dental implants that are oblique to each other, since the impression tray cannot be lifted without tilting or disadvantageous deflection of the impression posts.

The object of this invention is therefore to provide an impression post that can be used for a wide range of applications and for “open tray” impressions, which impression post ensures exact transfer of the position of the dental implants without movement of the impression posts relative to the impression material, especially when several dental implants are taken obliquely to each other at the same time.

This task is solved according to the invention by the impression post in accordance with claim 1. Advantageous embodiments are described in the depending claims.

More specifically, the invention concerns an impression post for a dental implant, which comprises a pair of sleeves with
an inner sleeve, which has a bore extending in the longitudinal direction of the inner sleeve, and
an outer sleeve radially surrounding the inner sleeve, which is detachably connected to the inner sleeve,
   and a fastening element penetrating the bore of the inner sleeve for fastening the pair of sleeves to the dental implant, wherein the outer sleeve has at the apical outer sleeve end facing the dental implant a preferably annular planar end face which, when the pair of sleeves is fastened to the dental implant, comes to rest on a corresponding, preferably planar end face of the dental implant.

According to the invention, it allows that after removal of the fastening element, the two planar end faces, i.e. the planar end face on the outer sleeve as well as the planar end face on the dental implant, which is fixedly implanted in the jaw, can be brought out of contact without hindrance. This is particularly advantageous in the case that several dental implants are impressed simultaneously with the impression tray over the impression posts and the impression tray allows radial to axial movement of the outer sleeve to the dental implant in relation to each implant. This compensates for any non-perpendicular alignment of one or more dental implants in relation to the jaw and allows unhindered removal of the impression tray.

In accordance with the invention, the planar end face on the outer sleeve is arranged in such a way that an almost unhindered radial movement of the outer sleeve to the dental implant is possible without projections on the outer sleeve and/or dental implant interfering with the other component and hindering this movement.

According to the present invention, the pair of sleeves of the impression post comprises an inner sleeve and an outer sleeve surrounding the inner sleeve radially on the outside, which is detachably connected to the inner sleeve. The inner sleeve is arranged between the fastening element and the outer sleeve, whereby the outer sleeve prevents contact between the inner sleeve and the impression material underneath the cover sleeve. In accordance with the invention, both the inner sleeve and the outer sleeve are preferably designed as hollow cylinders, wherein the inner sleeve is designed to receive the fastening element.

The formation of the sleeve pair as a pair of inner sleeve and outer sleeve allows the connection, i.e. the contact between the planar end face of the outer sleeve of the sleeve pair and the planar end face on the dental implant, to be removed in a first step after curing of the impression material. For this purpose, the fastening element is removed from the dental implant and the inner sleeve is pulled out in an occlusal direction until the inner sleeve is arranged with the apical end in the outer sleeve. This displacement of the inner sleeve in the longitudinal direction of the outer sleeve of the pair of sleeves fixed in the impression material keeps the outer sleeve stationary in the surrounding impression material. In this step, the inner sleeve is pulled out in the axial direction.

In a second step, the impression tray with the impression material and the embedded outer sleeve can be removed.

According to the invention, the outer sleeve has a planar end face at the apical end, which is intended to lie on a corresponding planar end face of the dental implant in the assembled state and thus allow unhindered mobility after removal of the fastening element and the inner sleeve. In contrast to the impression posts known in the state of the art, the outer sleeve and the dental implant are, according to the invention, movable against each other after removal of the fastening element and at least partial withdrawal of the inner sleeve, without elements of the outer sleeve or dental implant colliding with each other, exhibiting static friction against each other and restricting movement.

The planar end face on the side of the outer sleeve as well as the corresponding planar end face on the dental implant can, according to the invention, each consist of partial faces which come into contact with each other when the impression post is attached to the dental implant. The decisive factor for the design of the planar end face as several planar faces is that radial mobility of the outer sleeve and the dental implant is not or only insignificantly impaired after loosening the fastening element, so that removal of the impression tray is not impeded, especially in the case of several simultaneously impressed positions of, for example, four dental implants.

According to the invention, the inner sleeve and the outer sleeve are detachably connected, whereby the inner surface of the outer sleeve lies at least partially on the outer surface of the inner sleeve. Generally, the inner sleeve and outer sleeve can only be moved occlusally to each other in the longitudinal direction. In one design, the inner sleeve and/or outer sleeve are hollow cylindrical and the outer sleeve—in the case of impression posts not attached to the dental implant—is arranged rotatably around the inner sleeve. In order to ensure a stationary arrangement of the outer sleeve when attaching the impression post to the dental implant, the inner sleeve has at its occlusal end a type of non-circular, e.g. trigonal or trilobal, sleeve head which can be arranged in a corresponding non-circular, e.g. trigonal or trilobal, receptacle on the outer sleeve.

According to one embodiment, the inner sleeve has an anti-rotation lock between the inner sleeve and the dental implant that is designed to fix the position of the inner sleeve relative to the dental implant. This enables the axial alignment of the dental implant to the surrounding tissue as well as its axial position to be transferred exactly to the master model.

The dental implant anti-rotation lock can be designed in the form of at least one face which, when the pair of sleeves is attached to the dental implant, interacts with a corresponding face on the dental implant to limit the rotatability of the inner sleeve relative to the dental implant. Thereby the dental implant anti-rotation lock can be formed on the inner sleeve in the form of two to six positive locking grooves, which are engaged with corresponding spring webs on the dental implant in the manner of a tongue-and-groove connection when the pair of sleeves is attached to the dental implant, and/or in the form of two to six outer polygonal faces, which are engaged with corresponding inner polygonal faces on the dental implant when the sleeve pair is attached to the dental implant.

As described above, the most possible accurate transfer of the position of the dental implant to the master cast is additionally ensured if the inner sleeve furthermore has an anti-rotation lock between the inner sleeve of the outer sleeve, for example in the form of a non-circular sleeve head, so that the inner sleeve and the outer sleeve are arranged in a circumferentially stationary position relative to each other. This ensures that the information regarding the axial position is transferred not only from the dental implant to the inner sleeve, but also from the inner sleeve to the outer sleeve remaining in the impression material. This anti-rotation lock may also be in the form of a longitudinal groove on the outside of the inner sleeve, which is engaged by a locking element, such as a spring or a projection, arranged accordingly on the outer sleeve.

According to a further embodiment, the inner sleeve and the outer sleeve are arranged in a circumferentially fixed position relative to each other. With reference to the anti-rotation lock described above, this can be achieved, for example, by having only a single groove and a single tongue engaging in this groove in the manner of a tongue-and-groove connection. Therefore, the rotational position of the dental implant can be clearly assigned to the implant analog or transferred to the master model via the outer sleeve remaining in the impression material.

In a particularly simple and therefore preferred embodiment, the inner sleeve and the outer sleeve are arranged coaxially to each other.

Furthermore, it is advantageous if the outer sleeve has a profile on its outer surface which allows an intimate form fit between the outer sleeve of the pair of sleeves and the curable impression material. Profiling may take the form in particular of recesses, projections, usually at an angle, particularly perpendicular to the longitudinal direction of the impression post, from the outer surface of the outer sleeve.

According to the invention, the inner sleeve has a recess extending in its longitudinal direction. As a rule, this is essentially cylindrical. The recess is penetrated by a fastening element for fastening the pair of sleeves to the dental implant.

Generally, the fastening element is in the form of a screw. This has an external thread corresponding to an internal thread of the occlusal opening of the dental implant. In accordance with such an embodiment, the fastening element in its occlusal end region, i.e. in the assembled state facing away from the dental implant, has a head part with an abutment face, for example in the form of a sleeve head, which is intended to cooperate with an end face counter abutment face of the inner sleeve and the outer sleeve in such a way that the inner sleeve and the outer sleeve can be connected to the dental implant in a displaceable manner. This ensures that both the inner and outer sleeves are held in position longitudinally during impression taking, further ensuring accurate transfer of the position of the dental implant to the master cast.

According to an embodiment, the fastening element has a driving element which is intended to cooperate with a corresponding driving counter element of the inner sleeve in order to drive the inner sleeve when the fastening element is tightened. In this case, the fastening element can be a cylindrical screw with an outer collar arranged between the screw head and the screw thread, which outer collar is intended to cooperate with a corresponding inner collar of the inner sleeve in such a way that, when the screw is displaced in the direction away from the dental implant, the inner sleeve is taken together and, when the fastening element is tightened, the inner sleeve and, via the inner sleeve, the outer sleeve, too, are fixed stationary relative to the dental implant.

The fastening element may also have a driving element which is intended to cooperate with a corresponding driving counter-element on the inner sleeve in such a way as to drive the inner sleeve in the occlusal direction away from the dental implant when the fastening element is displaced. Such a driving element can be formed, for example, by the external thread section of the fastening element, while the driving counter-element can take, for example, the form of an internal thread on the inner sleeve projecting into the through-bore of the fastening element.

This ensures that the removal of the fastening element and the inner sleeve can be performed in a single step, without the need to remove the inner sleeve in a separate step, which can be costly. The removal can be limited by means of corresponding collars to the extent that the inner sleeve is drawn into the outer sleeve to such an extent that the outer sleeve can be displaced radially relative to the dental implant and at the same time the occlusal end of the inner sleeve does not yet protrude from the impression tray.

Furthermore, the fastening element can be positively connected to the inner sleeve. This positive locking provides additional protection against loss of the fastening element or inner sleeve.

In accordance with an embodiment, the fastening element in its occlusal end region, i.e. in the assembled state facing away from the dental implant, has a head part with a stop face, which is intended to cooperate with an end face counter stop face of the inner sleeve and the outer sleeve in such a way that the inner sleeve and the outer sleeve can be connected to the dental implant in a displaceable manner. This ensures that both the inner and outer sleeves are held in position longitudinally during impression taking, further ensuring accurate transfer of the position of the dental implant to the master cast.

Generally, the inner sleeve and the fastening element of the inventive impression post are made of metal, while the outer sleeve may be made of metal or plastic. For each individual component, however, any other material suitable for the corresponding purpose is also conceivable.

As explained above, the present invention allows the step, in which the connection between the pair of sleeves and the dental implant is broken and the impression tray with the impression material is removed from the dental implant, to be performed in two separate steps.

Accordingly, the invention also concerns a dental implant with an impression post as described above, which has a preferably annular occlusal planar end face which, when the pair of sleeves is attached to the dental implant, comes to rest on a corresponding preferably terminal planar end face of the outer sleeve of the pair of sleeves.

Furthermore, the invention also concerns method for taking an impression of a dental implant with an impression post in accordance with the invention, wherein
at least one pair of sleeves is fixed to a dental implant arranged in the jaw by means of a respective fastening element,
the at least one impression post and the tissue and denture structures surrounding it in each case are formed with an impression material arranged in an open tray,
the respective fastening element is released and thus the contact between the pair of sleeves and the dental implant is eliminated,
optionally, the respective fastening element and the inner sleeve can be removed from the impression material, and
the open tray containing the impression material is separated from the dental implant by the outer sleeve of the pair of sleeves surrounded by the impression material and the structures impressed in the impression material.

The open tray with the impression material structured in this way can then be used to fabricate a master cast. First, a dental implant analog is fixed to the structured impression side using the outer sleeve, inner sleeve and fastening element surrounded by the impression material, and the tissue and denture structures surrounding the dental implant analog in the impression material arranged in the open tray are impressed into a master model with, for example, gypsum.

Thus, the invention also concerns the use of the inventive impression post for the “open tray”-impression.

The invention is further explained with the help of the figures.

### BRIEF DESCRIPTION OF THE DRAWINGS

FIG. 1 on the left, a schematic plan view of an inventive impression post 10 with outer sleeve 30, inner sleeve 50 and fastening element 70 as well as in FIG. 1 on the right a cross-section of the inventive impression post along the sectional plane A-A;

FIG. 2 on the top a schematic plan view of the outer sleeve 30, therebelow a top view of the outer sleeve according to the invention from above and therebelow a top view of the outer sleeve according to the invention from below;

FIG. 3 on the top an inventive inner sleeve 50 in schematic plan view, therebelow in top view from above, therebelow in top view from below on the inventive inner sleeve;

FIG. 4 above a schematic plan view of the fastening element in accordance with the invention, therebelow a top view of the fastening element from above, therebelow a top view of the fastening element from below, and

FIG. 5 on the left, a schematic plan view of an inventive sleeve cap 90, including a plan view of the inventive sleeve cap from above and below a plan view of the inventive sleeve cap from below, and a cross-section of the inventive sleeve cap along the section plane A-A in FIG. 5 on the right.

### DETAILED DESCRIPTION OF THE INVENTION

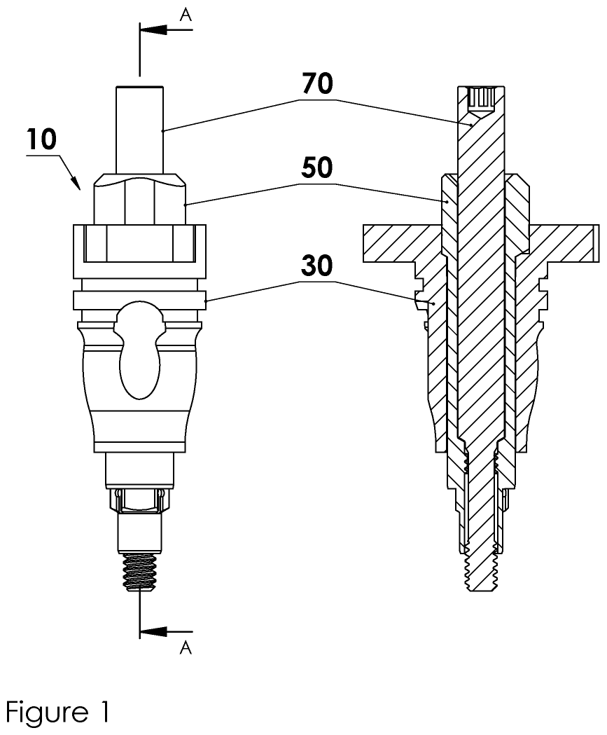

As shown in FIG. 1, the inventive impression post 10 comprises a pair of sleeves with an outer sleeve 30 and an inner sleeve 50 with a substantially hollow cylindrical recess extending axially to the pair of sleeves and a fastening element 70 arranged in the recess, generally in the form of a screw.

The pair of sleeves comprises a radially internal inner sleeve 50 and a radially external outer sleeve 30 arranged coaxially to this, so that the inner sleeve 50 is arranged between the outer sleeve 30 and the fastening element 70.

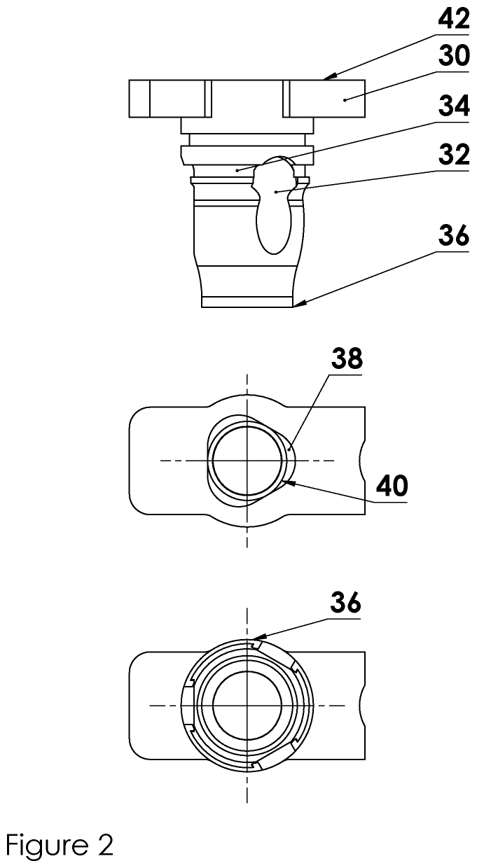

As can be seen in FIG. 2, the essentially hollow cylindrical outer sleeve 30 has flattenings 32 at its circumference and annular recesses 34, which serve to profile the anchorage of the outer sleeve in the impression material. The purpose of the profile designed in this way is to ensure a tight fit between the outer sleeve 30 and the impression material during impression taking. As shown in the middle picture of FIG. 2, the outer sleeve is provided at its upper end with a, for example trigonal, recess 38 occlusal above an inner collar 40, which allows a relative rotational fixation of outer sleeve 30 and inner sleeve 50 to each other.

In the plan view from below shown in FIG. 2, the lower planar end face 36 is shown at the lower end of the outer sleeve 30, which is supported on a corresponding planar end face on the dental implant, which is not shown, when the impression posts are fixed on the dental implant. The planar end face 36 can also be created from several partial planar end faces on corresponding partial planar end faces on the dental implant, which is not shown. These partial planar end faces can also lie at different levels in the axial direction, provided that the radial displaceability is not impaired when the outer sleeve 30 is removed from the dental implant.

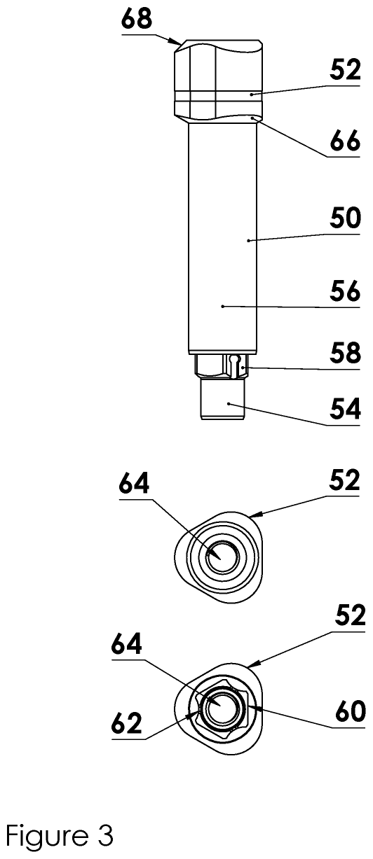

The inner sleeve 50 shown in FIG. 3 above has a sleeve head 52, a hollow cylindrical middle section 56, an adjoining anti-rotation lock section 58 and a guide section 54, the latter being engageable with a corresponding guide section in the dental implant. The sleeve head 52 preferably has a marking, for example a circumferential groove or profile, which is covered by the recess 38 when the inner sleeve is in the correct vertical position in the impression position.

In the middle picture of FIG. 3, the inventive inner sleeve 50 is shown in a top view from above. The through bore 64 and the exemplary trigonal/trilobal shape of the sleeve head 52 are shown in plan view. The trigonal/trilobal shape of the sleeve head 52, which can also be designed as a hex or similar, is adapted to a corresponding, e.g. trigonal/trigonal, recess 38 of the outer sleeve 30 in such a way that the outer sleeve 30 and the inner sleeve 50 are secured against rotation with respect to each other when the impression posts 10 are fixed to the dental implant. A shoulder 66 comes into contact with the inner collar 40 of the outer sleeve.

The sleeve head 52 is preferably axially dimensioned in such a way, that the sleeve head 52 protrudes axially occlusal from the recess 38, for example trigonal/trilobal, of the outer sleeve 30. The upper edge of the sleeve head is chamfered at each of the three bulges to a chamfer section 68, i.e. three chamfer sections 68 in total, which rest against the cone collar 94 of the inner sleeve cap 90.

In the through bore 64, a driving section, for example in the form of an internal thread, can be arranged above the anti-rotation lock section 58 in such a way that after the fastening element has been unscrewed from the dental implant, the connection between impression post and dental implant is loosened and the fastening element with the threaded section 76 rests on the driving section and thus can allow the internal sleeve to be pulled out of the external sleeve in the occlusal direction.

The plan view of the inventive inner sleeve 50 from below, shown in FIG. 3 below, shows the anti-rotation lock of the inner sleeve 50 with respect to the dental implant, which in the shown embodiment comprises outer polygonal faces 60 as well as grooves 62, which can interact with corresponding inner polygonal faces and tongues of the tongue-and-groove connection on the not shown dental implant in an anti-rotation manner.

Although the tongue-and-groove connection elements and/or inner polygons/outer polygons—anti-rotation lock elements pair arranged in the anti-rotation lock section 58 may each be used to provide anti-rotation lock between the inner sleeve and the dental implant, it is preferred, that at least inner polygon-outer polygon face pairs are used between inner sleeve and dental implant so that the tongue-and-groove connecting elements used for the alignment of the abutment are not damaged during the alignment of an abutment which is used in the course of the further dental prosthesis treatment.

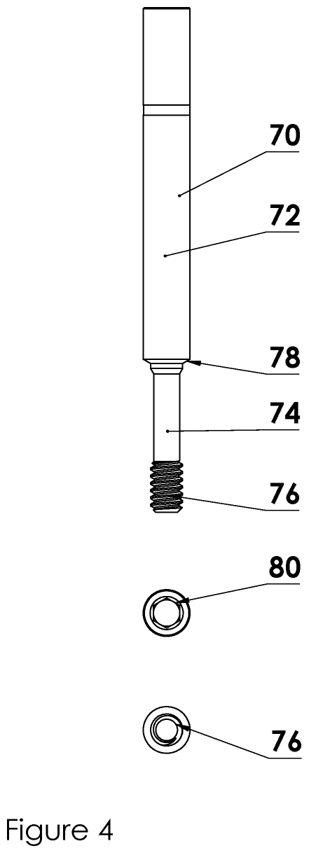

The fastening element 70 shown in FIG. 4 is formed in the shown embodiment in the form of a cylindrical screw with an upper occlusal section 72 of larger diameter, which can also be described as the screw head, and with a lower section 74 of smaller diameter than the screw head 72 and with an apically arranged external thread 76. Between the screw head 72 and the lower section 74, an outer collar 78 is formed in the transition area, which comes into contact with an inner collar 40 in the through bore 64 of the inner sleeve when the fastening element 70 is screwed into the dental implant and takes the outer sleeve 30 with it via the inner sleeve 50, thus securing the impression post 10 in position on the not shown dental implant. The outer collar 78 acts on the outer sleeve 30 via the sleeve head 52 arranged occlusally on the inner sleeve 50 and presses the planar end face 36 onto the corresponding planar end face of the not shown dental implant and fixes the impression post 10 in a secure position. The occlusal end of the fastening element preferably has a marking, for example a circumferential groove or profile, which is covered by the sleeve head 52 of the inner sleeve 50 when the fastening element is in the correct vertical position in the impression position.

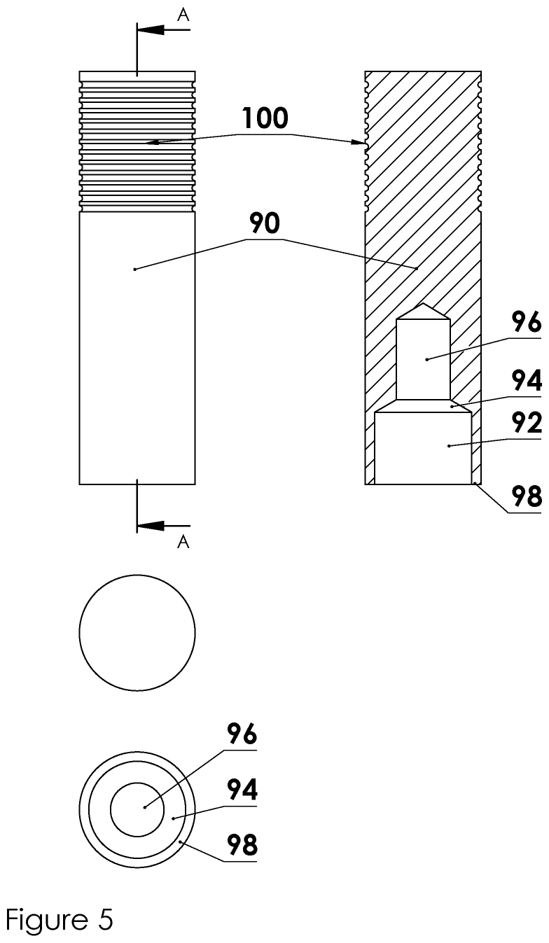

The sleeve cap 90 shown in FIG. 5 is designed, for example, as an equiradial cylinder and can be attached to the pair of sleeves to prevent the penetration of the impression material and the inclusion of the inner sleeve 50 and the fastening element 70 in the impression material. The sleeve cap 90 has an axial bore 92 in the lower section facing the pair of sleeves, which can also be designed as a through bore and which can taper occlusally to a bore 96 by forming an inner collar 94. With the annular face 98, the sleeve cap 90 comes into contact with the occlusal end face 42 of the outer sleeve when it is attached to the pair of sleeves on the occlusal end face 42 of the outer sleeve.

When using the inventive impression post, it is anchored in the dental implant to be formed, whereby the pair of sleeves is fastened with the fastening element. The stop face 36 of the outer sleeve is brought into contact with the counter stop face of the dental implant. The fastening element 70 is usually tightened by hand, usually with the aid of an Allen key, which is inserted into the Allen opening 80. After the sleeve cap has been attached to the sleeve pair, an impression is taken using the impression tray filled with impression material.

After the impression material has hardened, the sleeve cap 90 is first removed, whereby profiling 100 facilitates the removal. The fastening element is then usually loosened using an Allen key. The fastening element detached from the internal thread section of the dental implant can be moved axially occlusally with the internal sleeve, whereby the external threaded section 76 functions as a driving element and the internal thread of the internal sleeve 50 functions as a driving counter element.

After the impression material has cured, the impression tray with the impression material with the outer sleeve 30 embedded in it can be lifted off the dental implant and the outer sleeve connected to a dental implant analog. The resulting structure can then be used to produce a master model.

### REFERENCE SIGN LIST

impression post 10

outer sleeve 30

flattening portion 32

annular recess 34

planar end face 36

trigonal recess 38

inner collar 40

occlusal end face 42

inner sleeve 50

sleeve head 52

guide section 54

middle section 56

anti-rotation lock section 58

outer polygons 60

grooves 62

through bore 64

shoulder 66

chamfer section 68

fastening element 70

screw head 72

lower section 74

external threads 76

outer collar 78

sleeve cap 90

bore 92

inner collar 94

bore 96

annular face 98

profiling section 100

1. An impression post (10) for a dental implant, comprising:
one pair of sleeves with
an inner sleeve (50), which has a through bore (64) extending longitudinally of the inner sleeve (50), and
an outer sleeve (30) radially surrounding the inner sleeve (50), which is detachably connected to the inner sleeve (50), and
a fastening element (70) penetrating the through bore (64) of the inner sleeve (50) for fixing the sleeve pair to the dental implant,
wherein the outer sleeve (30) has, at the apical end of the outer sleeves (30) facing the dental implant, a preferably annular planar end face (36) which, when the sleeve pair is fixed to the dental implant, rests on a corresponding, preferably planar end face of the dental implant.

2. The impression post according to claim 1, wherein the planar end face of the outer sleeve consists of a plurality of partial surfaces and the partial surfaces can be brought into contact on one or more corresponding planar end faces of the dental implant during the attachment of the sleeve pair to the dental implant.

3. The impression post according to claim 1, wherein the inner sleeve has a dental implant anti-rotation lock, which is adapted to secure the position of the inner sleeve relative to the dental implant.

4. The impression post according to claim 3, wherein the dental implant anti-rotation lock is formed in the form of at least one face which, when the pair of sleeves is fixed to the dental implant, interacts with a corresponding face on the dental implant to limit the rotatability of the inner sleeve relative to the dental implant.

5. The impression post according to claim 3, wherein the dental implant anti-rotation lock is formed in the form of at least one tongue-groove connection which is engaged when the sleeve pair is fixed to the dental implant.

6. The impression post according to claim 3, wherein dental implant-anti-rotation locks are provided in the form of at least one face and in the form of at least one tongue-groove connection.

7. The impression post according to claim 1, wherein the inner sleeve and the outer sleeve are arranged in a circumferentially fixed position relative to each other.

8. The impression post according to claim 1, wherein the inner sleeve and the outer sleeve are arranged coaxially with each other.

9. The impression post according to claim 6, wherein the inner sleeve has at its occlusal end a sleeve head which, when the pair of sleeves is fixed to the dental implant, can be brought into a corresponding recess of the outer sleeve in rotationally secured engagement.

10. The impression post according to claim 1, wherein the outer sleeve has at least partially a profiling on its outer surface.

11. The impression post according to claim 1, wherein the fastening element can be positively connected to the inner sleeve.

12. The impression post according to claim 1, wherein the fastening element has a driving element which is adapted to cooperate with a corresponding driving counter element on the inner sleeve in such a way as to drive the inner sleeve during displacement of the fastening element in the direction away from the dental implant.

13. The impression post as claimed in claim 12, wherein the fastening element is a cylindrical screw having an outer collar arranged between the screw head and the screw thread, which is adapted to cooperate with a corresponding inner collar of the inner sleeve so as to drive the inner sleeve when the screw is displaced in the direction away from the dental implant.

14. The impression post according to claim 1, having a cylindrical sleeve cap which can be fitted onto the pair of sleeves in such a way that a preferably annular apical planar face comes to rest on a corresponding planar face of the pair of sleeves.

15. The impression post according to claim 1, wherein the inner sleeve and/or the fastening element has a marking which enables checking the correct position of the impression post to the dental implant.

16. A dental implant with an impression post according to claim 1, which has a preferably annular occlusal planar end face which, when the pair of sleeves is attached to the dental implant, comes to rest on a corresponding preferably terminal planar end face of the outer sleeve of the pair of sleeves.

17. A method for taking an impression of a dental implant with at least one impression post according to claim 1, wherein
at least one impression post (10) is fixedly fastened by a respective fastening element (70) to a respective dental implant arranged in the jaw,
the at least one impression post (10) and the tissue and denture structures surrounding it in each case are formed with an impression material arranged in an open tray,
the respective fastening element (70) is released,
optionally, the respective fastening element (70) and the inner sleeve (50) can be removed from the impression material, and
the open tray having the outer sleeve (30) surrounded by the impression material and the structures impressed in the impression material is separated from the dental implant.

18. Use of the impression post according to claim 1 for open tray impressions.
